(19) United States
(12) Patent Application Publication
(10) Pub. No.: US 2025/0112677 A1
(43) Pub. Date: Apr. 3, 2025

(54) ANTENNA CAPABILITY SWITCH METHOD AND APPARATUS, AND TERMINAL AND NETWORK-SIDE DEVICE

(71) Applicant: VIVO MOBILE COMMUNICATION CO., LTD., Dongguan (CN)

(72) Inventors: Wenjuan PU, Dongguan (CN); Xiaodong YANG, Dongguan (CN)

(73) Assignee: VIVO MOBILE COMMUNICATION CO., LTD., Dongguan (CN)

(21) Appl. No.: 18/977,917

(22) Filed: Dec. 12, 2024

Related U.S. Application Data
(63) Continuation of application No. PCT/CN2023/099152, filed on Jun. 8, 2023.

(30) Foreign Application Priority Data
Jun. 15, 2022 (CN) 202210680784.1

(51) Int. Cl. H04B 7/06; H04B 7/0413; H04W 8/20

(52) U.S. Cl. CPC H04B 7/0602; H04B 7/0413; H04W 8/205

(57) ABSTRACT

This application provides an antenna capability switch method and apparatus, and a terminal and a network-side device. The method includes: a terminal transmits first information to a network-side device. The network-side device corresponds to a first universal subscriber identity module (USIM) card of the terminal, and the first information includes information related to an antenna capability switch. The antenna capability switch includes at least one of the following: switching an antenna capability of the terminal from the first USIM card to another USIM card; switching an antenna capability of the terminal from another USIM card to the first USIM card; or adjusting the antenna capability of the terminal in the first USIM card.

### CROSS-REFERENCE TO RELATED APPLICATIONS

This application is a continuation of International Application No. PCT/CN 2023/099152, filed on Jun. 8, 2023, which claims priority to Chinese Patent Application No. 202210680784.1 filed on Jun. 15, 2022. The entire contents of each of the above-referenced applications are expressly incorporated herein by reference.

### TECHNICAL FIELD

This application relates to the technical field of communication, and in particular, to an antenna capability switch method and apparatus, and a terminal and a network-side device.

### BACKGROUND

A multi-universal subscriber identity module (MUSIM) card terminal refers to a terminal installed with more than one universal subscriber identity module (USIM) card. Taking a dual universal subscriber identity module card as an example, to support that double universal subscriber identity module cards are simultaneously in a radio resource control (RRC) connected state to transmit signals, there are two solutions at present: one solution is that, two sets of hardware or radio frequency is used to implement, which is equivalent to that two complete terminal motherboards are combined together and placed in the same terminal housing. Such an implementation mode can support two USIM cards working simultaneously, but has disadvantages such as high cost, high power consumption, and large device size. The other solution is that double cards can share part hardware or radio frequency of the terminal. The hardware or radio frequency are switched in networks of the double cards according to actual needs of the double cards. For example, when card 1 is in a connected state, card 2 is in an unconnected state, capabilities of the terminal are occupied by card 1. If card 2 will establish or restore an RRC connection, part capabilities of card 1 need to be switched to card 2. At this moment, network 1 will configure or schedule a terminal according to a capability of a user equipment (UE) previously reported by the terminal to result in that the terminal will lose data of network 1 or cause resource waste of network 1.

In conclusion, in a MUSIM scenario, the MUSIM card terminal may reuse some antennas among multiple USIM cards to save terminal costs and reduce size. However, in a case that part antennas of card 1 are switched to card 2, card 1 will have the following problems:

Problem 1: In a case that a multiple-in multiple-out (MIMO) capability of carrier 1 of card 1 is completely switched to card 2 in a MUSIM antenna switch, a switched carrier 1 does not have an antenna that can be configured to transmit.

Problem 2: In a case that an order of the MIMO of carrier 1 of card 1 is reduced in a MUSIM antenna switch, and the carrier 1 cannot perform data transmission due to dual card band interference, at this moment, a remaining MIMO capability of carrier 1 cannot be used either.

The above problems lead to an influence on transmission performance of card 1 after part antennas are switched from card 1 to card 2 in the MUSIM card terminal.

### SUMMARY

Embodiments of this application provide an antenna capability switch method and apparatus, and a terminal and a network-side device.

According to a first aspect, an antenna capability switch method is provided, including:
a terminal transmits first information to a network-side device. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

According to a second aspect, an antenna capability switch method is provided, including:
a network-side device receives first information transmitted by a terminal. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

According to a third aspect, an antenna capability switch apparatus is provided, including:
a first transmitting module, configured to transmit first information to a network-side device. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

According to a fourth aspect, an antenna capability switch apparatus is provided, including:
a first receiving module, configured to receive first information transmitted by a terminal. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

According to a fifth aspect, a terminal is provided. The terminal includes a processor and a memory, the memory stores a program or instructions executable on the processor, and the program or the instructions, when executed by the processor, implement steps of the method according to the first aspect.

According to a sixth aspect, a terminal is provided, including a processor and a communication interface. The communication interface is configured to transmit first information to a network-side device. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

According to a seventh aspect, a network-side device is provided. The network-side device includes a processor and a memory. The memory stores a program or instructions executable on the processor, and the program or the instructions, when executed by the processor, implement steps of the method according to the second aspect.

According to an eighth aspect, a network-side device is provided, including a processor and a communication interface. The communication interface is configured to receive first information transmitted by a terminal. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

According to a ninth aspect, a communication system is provided, including: a terminal and a network-side device. The terminal may be configured to perform steps of the method according to the first aspect. The network-side device may be configured to perform steps of the method according to the second aspect.

According to a tenth aspect, a readable storage medium is provided. The readable storage medium stores a program or instructions. The program or the instructions, when executed by a processor, implement steps of the method according to the first aspect, or implement steps of the method according to the second aspect.

According to an eleventh aspect, a chip is provided. The chip includes a processor and a communication interface. The communication interface is coupled to the processor. The processor is configured to execute a program or instructions to implement the method according to the first aspect or implement the method according to the second aspect.

According to a twelfth aspect, a computer program/a program product is provided. The computer program/the program product is stored in a storage medium. The computer program/the program product is executed by at least one processor to implement the method according to the first aspect, or implement steps of the method according to the second aspect.

In the embodiments of this application, a terminal transmits information related to an antenna capability switch to a network-side device corresponding to a first USIM card with the antenna capability switch, so that the network-side device can configure or schedule the terminal based on the information related to the antenna capability switch reported by the terminal, thereby reducing an influence of an antenna capability switch of a MUSIM card on performance of a current network side, and improving a user experience of a MUSIM card terminal.

### BRIEF DESCRIPTION OF THE DRAWINGS

FIG. 1 is a block diagram of a wireless communication system to which an embodiment of this application is applicable;

FIG. 2 is a first schematic flowchart of an antenna capability switch method according to an embodiment of this application;

FIG. 3 is a second schematic flowchart of an antenna capability switch method according to an embodiment of this application;

FIG. 4 is a first schematic structural diagram of an antenna capability switch apparatus according to an embodiment of this application;

FIG. 5 is a second schematic structural diagram of an antenna capability switch apparatus according to an embodiment of this application;

FIG. 6 is a schematic structural diagram of a communication device according to an embodiment of this application;

FIG. 7 is a schematic structural diagram of a terminal according to an embodiment of this application; and

FIG. 8 is a schematic structural diagram of a network-side device according to an embodiment of this application.

### DETAILED DESCRIPTION

Technical solutions in embodiments of this application are described in the following with reference to accompanying drawings in the embodiments of this application. Apparently, the described embodiments are merely some rather than all the embodiments of this application. All other embodiments obtained by those of ordinary skill in the art based on the embodiments of this application fall within the protection scope of this application.

Terms “first”, “second”, and the like in the specification and claims of this application are used to distinguish similar objects, but are unnecessarily used to describe a specific sequence or order. It is to be understood that the terms used in this way are exchangeable in a proper case, so that the embodiments of this application can be implemented in an order other than those shown or described herein, and objects distinguished by “first” and “second” are usually of the same category, and the number of the objects is not limited. For example, the first object may be one or multiple. In addition, “and/or” in the specification and the claims represents at least one of connected objects, and character “/” generally represents an “or” relationship between associated objects before and after.

It is worth pointing out that, technologies described in the embodiments of this application are not limited to a long term evolution (LTE)/LTE-advanced (LTE-A) system, and may be applied to other wireless communication systems such as code division multiple access (CDMA), time division multiple access (TDMA), frequency division multiple access (FDMA), orthogonal frequency division multiple access (OFDMA), single-carrier frequency division multiple access (SC-FDMA), and other systems. Terms “system” and “network” in the embodiments of this application may usually be used interchangeably. For example, the described technologies may be applied the above-mentioned system and radio technology, and may be applied to other systems and radio systems. The following description describes a new radio (NR) system for a purpose of giving examples, and the term NR is used in most of the following descriptions. However, in some embodiments, these technologies may be applied to applications other than an NR system application, for example, a 6th generation (6G) communication system.

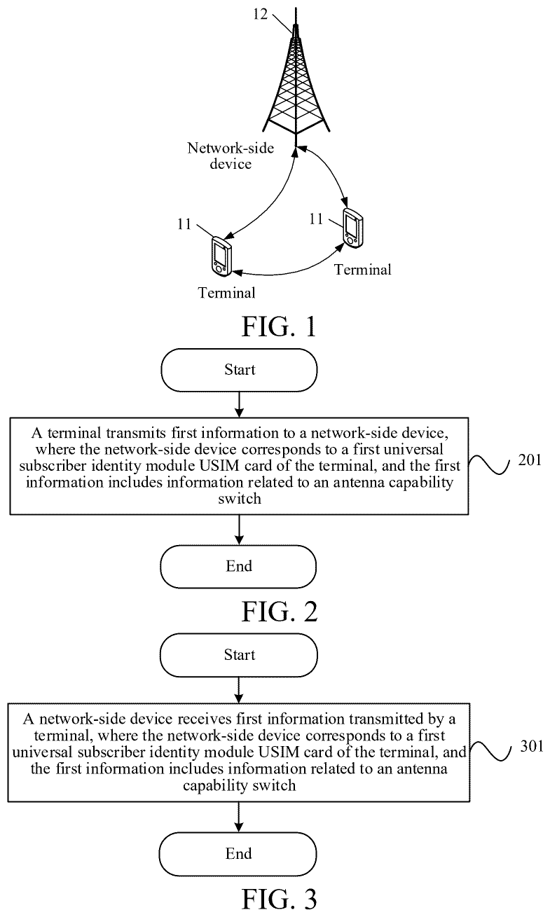

FIG. 1 is a block diagram of a wireless communication system to which an embodiment of this application is applicable. The wireless communication system includes a terminal 11 and a network-side device 12. The terminal 11 may be a terminal side device such as a mobile phone, a tablet personal computer, a laptop computer or referred to as a notebook computer, a personal digital assistant (PDA), a palm computer, a netbook, an ultra-mobile personal computer (UMPC), a mobile Internet device (MID), an augmented reality (AR)/virtual reality (VR) device, a robot, a wearable device, a vehicle user equipment (VUE), a pedestrian user equipment (PUE), a smart home device (a home device with a wireless communication function, such as a refrigerator, a television, a washing machine, or furniture), a game console, a personal computer (PC), an automatic teller machine, or a self-service machine. The wearable device includes: a smart watch, a smart bracelet, a smart headphone, smart glasses, smart jewelry (a smart bracelet, a smart bracelet, a smart ring, a smart necklace, a smart anklet, a smart ankle chain, and the like), a smart wristband, smart clothing, and the like. It is to be noted that, a specific type of the terminal 11 is not limited in the embodiments of this application. The network-side device 12 may include an access network device or a core network device. In some embodiments, the access network device may be referred to as a radio access network device, a Radio Access Network (RAN), a radio access network function, or a radio access network unit. The access network device may include a base station, a wireless local area network (WLAN) access point, or a Wireless Fidelity (WiFi) node, or the like. The base station may be referred to as a node B, an evolved node B (eNB), an access point, a base transceiver station (BTS), a radio base station, a radio transceiver, a basic service set (BSS), an extended service set (ESS), a home B node, a home evolved B node, a transmitting receiving point (TRP), or another appropriate term in the art. As long as the same technical effect is achieved, the base station is not limited to a specific technology vocabulary. It is to be noted that, in the embodiments of this application, an introduction is made by only taking the base station in the NR system as an example, and a specific type of the base station is not limited.

An antenna capability switch method and apparatus, and a terminal and a network-side device according to the embodiments of this application are described in detail below through some embodiments and application scenarios of the embodiments with reference to accompanying drawings.

As shown in FIG. 2, an embodiment of this application provides an antenna capability switch method, including the following steps.

Step 201: A terminal transmits first information to a network-side device. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

The adjusting the antenna capability of the terminal in the first USIM card includes:
adjusting the antenna capability of the terminal on at least one carrier on the first USIM card;
or,
switching the antenna capability of the terminal between at least one pair of carriers on the first USIM card.

It is to be noted that, the antenna capability switch may be referred to as antenna capability switching in some embodiments, for example, switching part or all antenna capabilities from carrier 1 to carrier 2, which may be understood as: switching part or all antenna capabilities from carrier 1 to carrier 2. In some other specific embodiments, the antenna capability switch cannot be referred to as antenna capability switching, for example, reducing an antenna capability of carrier 1 from 3 MIMO to 1 MIMO. In this case, the antenna capability switch may be understood as: performing the antenna capability switch on carrier 1.

It is to be noted that, an antenna capability may include at least one of the following: a radio frequency chain (RF chain), a transmitting chain (Tx chain), a receiving chain (Rx chain), transmitting (Tx), receiving (Rx), a MIMO layer, a port, a panel, and a beam. Further, the antenna capability may be uplink and/or downlink.

In the embodiments of this application, a terminal transmits information related to an antenna capability switch to a network-side device corresponding to a first USIM card with the antenna capability switch, so that the network-side device can configure or schedule the terminal based on the information related to the antenna capability switch reported by the terminal, thereby reducing an influence of an antenna capability switch of a MUSIM card on performance of a current network side, and improving a user experience of a MUSIM card terminal.

In at least one embodiment of this application, in a case that the information related to the antenna capability switch is used to request to switch the antenna capability of the terminal, the information related to the antenna capability switch includes at least one of the following:
an identifier of a first carrier, the first carrier being a carrier from which the antenna capability is expected to be switched by the terminal;
an identifier of a second carrier, the second carrier being a carrier to which the antenna capability is expected to be switched by the terminal;
a quantity of switched antennas; for example, a quantity of transmitting and/or receiving antennas switched from a first carrier to a second carrier;
time required for the terminal to perform an antenna switch between the first carrier and the second carrier; and
information of a carrier affected in a case that the terminal performs the antenna switch between the first carrier and the second carrier.

Following the example above, in a case that the first information includes an antenna capability switch request, the method further includes:
receiving antenna capability switch information transmitted by the network-side device. The antenna capability switch information includes at least one of the following:
accepting the antenna capability switch request;
refusing the antenna capability switch request;
an identifier of a carrier indicating the terminal to switch the antenna capability, for example, an identifier of carrier A, where carrier A may be the same as the first carrier, or may be different from the first carrier;
an identifier of a carrier indicating the terminal to switch in an antenna capability, for example, an identifier of carrier B, where carrier B may be the same as the second carrier, or may be different from the second carrier; and
a quantity of switched antennas, for example, a quantity of transmitting and/or receiving antennas switched from carrier A to carrier B.

As an example embodiment, the above first information may be an RRC message or a media access control element (MAC CE).

As another example embodiment, the above antenna capability switch information may be an RRC message or a MAC CE.

### Example One: A Terminal Indicates an Antenna Switch of a Carrier Pair Through an Antenna Capability Switch Request

Step 1: UE1 reports a MIMO capability of UE1 to a network side. For example, indicating the UE1 supports two downlink multiple-in multiple-out layers (2 DL MIMO layers) in Band 1, Band 2, and Band 3, respectively.

Step 2: UE1 is configured with three carriers, and each of carrier 1, carrier 2, and carrier 3 has two maximum downlink multiple-in multiple-out layers (max DL MIMO layers). The three carriers are respectively in band1, band2, and band3.

UE2 initiates RRC connection establishment in card 2. A MUSIM card terminal determines to remove two MIMO layers of a carrier (for example, carrier 1) of UE1 according to internal implementation.

Step 3: UE1 requests the network side to decrease the MIMO layer of carrier 1 to 0 for a MUSIM switch purpose.

Step 4: UE1 transmits an antenna capability switch request to request to switch 2 MIMO of carrier 3 to carrier 1. The antenna capability switch request includes the following domains:
first carrier: 3;
second carrier: 1;
MIMO layer: 2; and
direction: downlink.

Step 5: UE1 receives antenna capability switch information to indicate the terminal to switch 2 MIMO of carrier 3 to carrier 1. A first downlink message includes the following domains:
carrier A: 3;
carrier B: 1; and
MIMO layer: 2.

In at least one example embodiment of this application, on a network side, due to a policy on the network side, for example, whether there is downlink data to be transmitted to a carrier and a load of a carrier, the network side may have a preference of the network side, so that the network side may indicate that a carrier pair of the terminal that performs an antenna switch and a switched antenna quantity are different from the preference reported by the terminal. On this basis, the terminal may report the carrier pair of the terminal that supports the antenna switch to the network side first. When an antenna switch needs to be performed, which carrier pair to use may be negotiated between the terminal and the network side or may be separately determined by the network side. In some embodiments, before transmitting the first information to the network-side device, the method further includes:
transmitting first capability information to the network-side device. The first capability information is used to indicate a capability of the terminal to perform the antenna capability switch. The first capability information includes at least one of the following:
one or more band combinations (BCs) of the terminal supporting the antenna capability switch;
one or more band pairs of the terminal supporting the antenna capability switch;
one or more carrier pairs of the terminal supporting the antenna capability switch;
time required for the terminal to perform the antenna capability switch;
a quantity of switched antennas supported by the terminal, for example, MIMO layers;
information of a band or a carrier affected during performing the antenna capability switch by the terminal, for example, a band list or a carrier list; and
a characteristic supported by the terminal on a band combination supporting the antenna capability switch.

As an example embodiment, the above first capability information may be an RRC message, for example, UE capability information or UE assistance information.

Following the above example, in a case that the terminal transmits the first capability information, the method further includes:
the terminal receives at least one set of antenna switch configuration information transmitted by the network-side device. Each set of antenna switch configuration information is associated with a pair of candidate carriers. A set of the antenna switch configuration information includes at least one of the following:
an identifier of a carrier from which the antenna capability is switched;
an identifier of a carrier to which the antenna capability is switched; and
a quantity of switched antennas, for example, switched MIMO layers.

As an example embodiment, in a case that the network-side device transmits at least two sets of antenna switch configuration information, the method further includes:
the terminal receives second information transmitted by the network-side device. The second information is used to trigger an antenna switch corresponding to one set of antenna switch configuration information of the at least two sets of antenna switch configuration information. For example, the network-side device uses the RRC message to configure at least two sets of antenna switch configuration information, and then triggers an antenna switch by using downlink control information (DCI) or a MAC CE or in a timer-based mode.

In some embodiments, before receiving the second information, the terminal further requests to trigger the antenna switch from the network side, and then receives the second information transmitted by the network side.

As another example embodiment, in a case that the network-side device transmits one set of antenna switch configuration information, the one set of antenna switch configuration information is further used to trigger a corresponding antenna switch. For example, in a case that only one set of antenna switch configuration information is configured in the RRC message, this set of configuration is directly activated, that is, the antenna switch on this pair of carriers is directly triggered. In addition, in some embodiments, the network side may directly indicate to perform the antenna switch between a pair of carriers through the DCI or the MAC CE.

### Example Two: A Terminal Transmits First Capability Information, and a Network Pre-Configures a Configuration of an Antenna Switch and Triggers a Switch by Using Low-Level Signaling

Step 1: UE1 reports a MIMO capability of UE1 to a network side. For example, indicating that UE1 supports 2 DL MIMO layers in Band1, Band2, and Band3.

Step 2: UE1 transmits first capability information to the network side. The first capability information includes at least one of the following:
indicating that the terminal supports performing a downlink antenna switch on BC={Band1, Band2, Band3};
in this BC, indicating that the terminal supports performing a downlink antenna switch on two band pairs of {band1, band2} and {band1, band3};
indicating a quantity of antennas that the terminal supports or expects to switch on a supported band pair, for example, 1 RX MIMO and 1 DL MIMO; and
indicating time required for the terminal to perform a downlink antenna switch, where the time may be based on per band pair, or may be based on per BC.

Step 3: UE1 is configured with three carriers, each of carrier 1, carrier 2, and carrier 3 has two max DL MIMO layers, and the three carriers are respectively in band1, band2, and band3.

Step 4: UE1 receives the antenna switch configuration information transmitted by the network side. For example, indicating two candidate carrier pairs:
pair 1:1 MIMO of carrier 1 is switched to carrier 2; and
pair 2:1 MIMO of carrier 1 is switched to carrier 3.

UE2 initiates RRC connection establishment in card 2. A MUSIM card terminal determines to remove one MIMO layer of a carrier (for example, carrier 1) of UE1 according to internal implementation.

Step 5: UE1 transmits a first request to the network side to request to perform an antenna capability switch, which may be an RRC or a MAC CE or DCI signaling.

Step 6: UE1 receives a first MAC CE. In a case that the network side in step 4 is configured with multiple candidate pairs, the first MAC CE indicates which carrier pair triggers the antenna switch (for example, pair 1). In a case that only one candidate pair is configured in step 4, the first MAC CE directly triggers the antenna switch of this pair of carriers.

The current terminal may transmit UE assistance information to the network side for a purpose of overheating or power saving, which indicates max MIMO layers expected by the terminal, so as to relieve overheating and save power. The UE assistance information can only indicate the MIMO layers that the terminal wants to decrease on all carriers, but cannot indicate that the terminal wants to reduce an order of the MIMO layer on a carrier. To switch the antenna capability between a pair of carriers, in the embodiments of this application, the UE assistance information is improved as follows: the first information further includes terminal assistance information, and the terminal assistance information includes at least one of the following:
multiple-in multiple-out MIMO layers that the terminal expects to decrease on a third carrier;
MIMO layers that the terminal expects to increase on a fourth carrier; and
purpose information for transmitting the terminal assistance information, for example, the purpose information is related to a MUSIM switch.

Following the example above, in a case that the first information includes the terminal assistance information, the method further includes:
the terminal receives antenna configuration information transmitted by the network-side device. The antenna configuration information includes at least one of the following:
maximum MIMO layers of the third carrier; and
maximum MIMO layers of the fourth carrier.

### Example Three: The Terminal Transmits UE Assistance Information (UAI)

Step 1: UE1 reports a MIMO capability of UE1 to a network side. For example, indicating that UE1 supports 2 DL MIMO layers in Band1, Band2, and Band3.

Step 2: UE1 is configured with three carriers, each of carrier 1, carrier 2, and carrier 3 has two max DL MIMO layers, and the three carriers are respectively in Band1, Band2, and Band3.

UE2 initiates RRC connection establishment in card 2. A MUSIM card terminal determines to remove one MIMO layer of a carrier (for example, carrier 1) of UE1 according to internal implementation.

Step 3: UE1 requests the network side to decrease the MIMO layer of carrier 1 to 0 for a MUSIM switch purpose.

Step 4: UE1 transmits first UAI to the network side, which indicates that the DL MIMO layer of carrier 1 is increased to 2, and the DL MIMO layer of carrier 2 will be 0.

Step 5: UE1 receives an RRC reconfiguration message, the max MIMO layer of carrier 1 is configured to be 2, and the max MIMO layer of carrier 2 is configured to be 0.

In at least one embodiment of this application, when the MUSIM card terminal switches some capabilities from card 1 to card 2, there is a demand for adjusting capability distributions of the terminal in different bands/different carriers of card 1, and the terminal may report capabilities of two sets of UE when reporting the capability of the UE, which is as follows: the first information further includes second capability information of the terminal, and the second capability information includes:
a first capability set, the first capability set being used to indicate a terminal capability corresponding to the first USIM card in a case that the terminal does not switch the antenna capability from the first USIM card to another USIM card; and
a second capability set, the second capability set being used to indicate a terminal capability corresponding to the first USIM card in a case that the terminal switches the antenna capability from the first USIM card to another USIM card.

Further, the second capability information further includes:
time required for the terminal to switch from the first capability set to the second capability set.

Following the example above, in a case that the first information includes the first capability set and the second capability set, the method further includes:
the terminal receives antenna configuration information transmitted by the network-side device. The antenna configuration information includes at least one of the following:
maximum MIMO layers of the third carrier; and
maximum MIMO layers of the fourth carrier.

In still another example embodiment of this application, in a case that after the terminal switches the antenna capability of carrier 1 from card 1 to card 2, the network side may be requested to switch a state of carrier 1, the method further includes:
the terminal transmits third information to the network-side device in a case that the antenna capability of a target carrier of the first USIM is switched. The third information is used to indicate an expected state of the target carrier. The expected state includes at least one of the following: a release state, an activated state, a deactivated state, and a dormant state.

For example, in a case that after the terminal switches the antenna capability of carrier 1 from card 1 to card 2, and carrier 1 does not have a demand for data transmission at present, the network side may be requested to deactivate or release carrier 1.

Following the above example, the method further includes:
the terminal receives fourth information transmitted by the network-side device. The fourth information is used to indicate the terminal to switch a state of the target carrier to a first state. The first state includes at least one of the following: a release state, an activated state, a deactivated state, and a dormant state.

In an example embodiment of this application, the method further includes:
the terminal receives fifth information transmitted by the network-side device. The fifth information is used to indicate whether to allow the terminal to transmit the first information. For example, in a case that the fifth information indicates that the terminal is allowed to transmit the first information, the terminal transmits the first information to the network-side device. In a case that the fifth information indicates the terminal is not allowed to transmit the first information, the terminal does not transmit the first information to the network-side device.

In some embodiments, the method further includes:
the terminal transmits sixth information to the network-side device. The sixth information is used to indicate whether the terminal supports transmitting the first information. For example, in a case that the sixth information indicates that the terminal supports transmitting the first information, the terminal transmits the first information to the network-side device. In a case that the sixth information indicates that the terminal does not support transmitting the first information, the terminal does not transmit the first information to the network-side device.

In conclusion, in the embodiments of this application, a terminal transmits information related to an antenna capability switch to a network-side device corresponding to a first USIM card with the antenna capability switch, so that the network-side device can configure or schedule based on the information related to the antenna capability switch reported by the terminal, thereby reducing an influence of an antenna capability switch of a MUSIM card on performance of a current network side, and improving a user experience of a MUSIM card terminal.

As shown in FIG. 3, an embodiment of this application further provides antenna capability switch method, including the following steps.

Step 301: A network-side device receives first information transmitted by a terminal. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.
The adjusting the antenna capability of the terminal in the first USIM card includes:
adjusting the antenna capability of the terminal on at least one carrier on the first USIM card;
or,
switching the antenna capability of the terminal between at least one pair of carriers on the first USIM card.

In the embodiments of this application, a terminal transmits information related to an antenna capability switch to a network-side device corresponding to a first USIM card with the antenna capability switch, so that the network-side device can configure or schedule a MUSIM card capability switch of the terminal based on the information related to the antenna capability switch reported by the terminal, thereby reducing an influence of the MUSIM card capability switch on performance of a current network side, and improving a user experience of a MUSIM card terminal.

In at least one embodiment of this application, in a case that the information related to the antenna capability switch is used to request to switch the antenna capability of the terminal, the information related to the antenna capability switch includes at least one of the following:
an identifier of a first carrier, the first carrier being a carrier from which the antenna capability is expected to be switched by the terminal;
an identifier of a second carrier, the second carrier being a carrier to which the antenna capability is expected to be switched by the terminal;
a quantity of switched antennas; for example, a quantity of transmitting and/or receiving antennas switched from a first carrier to a second carrier;
time required for the terminal to perform an antenna switch between the first carrier and the second carrier; and
information of a carrier affected in a case that the terminal performs the antenna switch between the first carrier and the second carrier.

Following the example above, in a case that the first information includes an antenna capability switch request, the method further includes:
the network-side device transmits antenna capability switch response information to the terminal. The antenna capability switch response information includes at least one of the following:
accepting the antenna capability switch request;
refusing the antenna capability switch request;
an identifier of a carrier indicating the terminal to switch the antenna capability, for example, an identifier of carrier A, where carrier A may be the same as the first carrier, or may be different from the first carrier;
an identifier of a carrier indicating the terminal to switch in an antenna capability, for example, an identifier of carrier B, where carrier B may be the same as the second carrier, or may be different from the second carrier; and
a quantity of switched antennas, for example, a quantity of transmitting and/or receiving antennas switched from carrier A to carrier B.

As an example embodiment, the above first information may be an RRC message or a MAC CE.

As another example embodiment, the above antenna capability switch information may be an RRC message or a MAC CE.

In at least one example embodiment of this application, on a network side, due to a policy on the network side, for example, whether there is downlink data to be transmitted to a carrier and a load of a carrier, the network side may have a preference of the network side, so that the network side may indicate that a carrier pair of the terminal that performs an antenna switch and a switched antenna quantity are different from the preference reported by the terminal. On this basis, the terminal may report the carrier pair of the terminal that supports the antenna switch to the network side first. When an antenna switch needs to be performed, which carrier pair to use may be negotiated between the terminal and the network side or may be separately determined by the network side. In some embodiments, before receiving the first information transmitted by the terminal, the method further includes:

receiving first capability information transmitted by the terminal. The first capability information is used to indicate a capability of the terminal to perform the antenna capability switch. The first capability information includes at least one of the following:
one or more BCs of the terminal supporting the antenna capability switch;
one or more band pairs of the terminal supporting the antenna capability switch;
one or more carrier pairs of the terminal supporting the antenna capability switch;
time required for the terminal to perform the antenna capability switch;
a quantity of switched antennas supported by the terminal, for example, MIMO layers;
information of a band or a carrier affected during performing the antenna capability switch by the terminal, for example, a band list or a carrier list; and
a characteristic supported by the terminal on a band combination supporting the antenna capability switch.

As an example embodiment, the above first capability information may be an RRC message, for example, UE capability information or UE assistance information.

Following the above example, in a case that the terminal transmits the first capability information, the method further includes:
the network-side device transmits at least one set of antenna switch configuration information to the terminal. Each set of antenna switch configuration information is associated with a pair of candidate carriers. A set of the antenna switch configuration information includes at least one of the following:
an identifier of a carrier from which the antenna capability is switched;
an identifier of a carrier to which the antenna capability is switched; and
a quantity of switched antennas, for example, switched MIMO layers.

As an example embodiment, in a case that the network-side device transmits at least two sets of antenna switch configuration information, the method further includes:
the terminal receives second information transmitted by the network-side device. The second information is used to trigger an antenna switch corresponding to one set of antenna switch configuration information of the at least two sets of antenna switch configuration information. For example, the network-side device uses the RRC message to configure at least two sets of antenna switch configuration information, and then triggers an antenna switch by using DCI or a MAC CE or in a timer-based mode.

As another example embodiment, in a case that the network-side device transmits one set of antenna switch configuration information, the one set of antenna switch configuration information is further used to trigger a corresponding antenna switch. For example, the network-side device directly uses the DCI or the MAC CE to configure a set of antenna switch configuration information. The DCI or the MAC CE is directly used to trigger an antenna switch.

In at least one example embodiment of this application, the current terminal may transmit UE assistance information to the network side for a purpose of overheating or power saving, which indicates max MIMO layers expected by the terminal, so as to relieve overheating and save power. The UE assistance information can only indicate the MIMO layers that the terminal wants to decrease on all carriers, but cannot indicate that the terminal wants to reduce an order of the MIMO layer on a carrier. In some embodiments, to switch the antenna capability between a pair of carriers, the UE assistance information may be improved as follows: the first information further includes terminal assistance information, and the terminal assistance information includes at least one of the following:
multiple-in multiple-out MIMO layers that the terminal expects to decrease on a third carrier;
MIMO layers that the terminal expects to increase on a fourth carrier; and
purpose information for transmitting the terminal assistance information, for example, the purpose information is related to a MUSIM switch.

Following the example above, in a case that the first information includes the terminal assistance information, the method further includes:
the network-side device transmits antenna configuration information to the terminal. The antenna configuration information includes at least one of the following:
maximum MIMO layers of the third carrier; and
maximum MIMO layers of the fourth carrier.

In at least one embodiment of this application, when the MUSIM card terminal switches some capabilities from card 1 to card 2, there is a demand for adjusting capability distributions of the terminal in different bands/different carriers of card 1, and the terminal may report capabilities of two sets of UE when reporting the capability of the UE, which is as follows: the first information further includes second capability information, and the second capability information includes:
a first capability set, the first capability set being used to indicate a terminal capability corresponding to the first USIM card in a case that the terminal does not switch the antenna capability from the first USIM card to another USIM card; and
a second capability set, the second capability set being used to indicate a terminal capability corresponding to the first USIM card in a case that the terminal switches the antenna capability from the first USIM card to another USIM card.

Further, the second capability information further includes:
time required for the terminal to switch from the first capability set to the second capability set.

Following the example above, in a case that the first information includes the first capability set and the second capability set, the method further includes:
the network-side device transmits antenna configuration information to the terminal. The antenna configuration information includes at least one of the following:
maximum MIMO layers of the third carrier; and
maximum MIMO layers of the fourth carrier.

In still another example embodiment of this application, in a case that after the terminal switches the antenna capability of carrier 1 from card 1 to card 2, the network side may be requested to switch a state of carrier 1. In some embodiments, the method further includes:

the network-side device receives third information transmitted by the terminal. The third information is used to indicate an expected state of a target carrier from and/or to which the antenna capability is switched. The expected state includes at least one of the following: a release state, an activated state, a deactivated state, and a dormant state.

For example, in a case that after the terminal switches the antenna capability of carrier 1 from card 1 to card 2, and carrier 1 does not have a demand for data transmission at present, the network side may be requested to deactivate or release carrier 1.

Following the above example, the method further includes:
the network-side device transmits fourth information to the terminal. The fourth information is used to indicate the terminal to switch a state of the target carrier to a first state. The first state includes at least one of the following: a release state, an activated state, a deactivated state, and a dormant state.

In an example embodiment of this application, the method further includes:
the network-side device transmits fifth information to the terminal. The fifth information is used to indicate whether to allow the terminal to transmit the first information. For example, in a case that the fifth information indicates that the terminal is allowed to transmit the first information, the terminal transmits the first information to the network-side device. In a case that the fifth information indicates that the terminal is not allowed to transmit the first information, the terminal does not transmit the first information to the network-side device.

In some embodiments, the method further includes:
the network-side device receives sixth information transmitted by the terminal. The sixth information is used to indicate whether the terminal supports transmitting the first information. For example, in a case that the sixth information indicates that the terminal supports transmitting the first information, the terminal transmits the first information to the network-side device. In a case that the sixth information indicates that the terminal does not support transmitting the first information, the terminal does not transmit the first information to the network-side device.

In conclusion, in the embodiments of this application, a terminal transmits information related to an antenna capability switch to a network-side device corresponding to a first USIM card with the antenna capability switch, so that the network-side device can configure or schedule the terminal based on the information related to the antenna capability switch reported by the terminal, thereby reducing an influence of an antenna capability switch of a MUSIM card on performance of a current network side, and improving a user experience of a MUSIM card terminal.

The antenna capability switch method according to the embodiments of this application may be performed by an antenna capability switch apparatus. In the embodiments of this application, an antenna capability switch apparatus according to the embodiments of this application is described by taking the antenna capability switch apparatus performing the antenna capability switch method as an example.

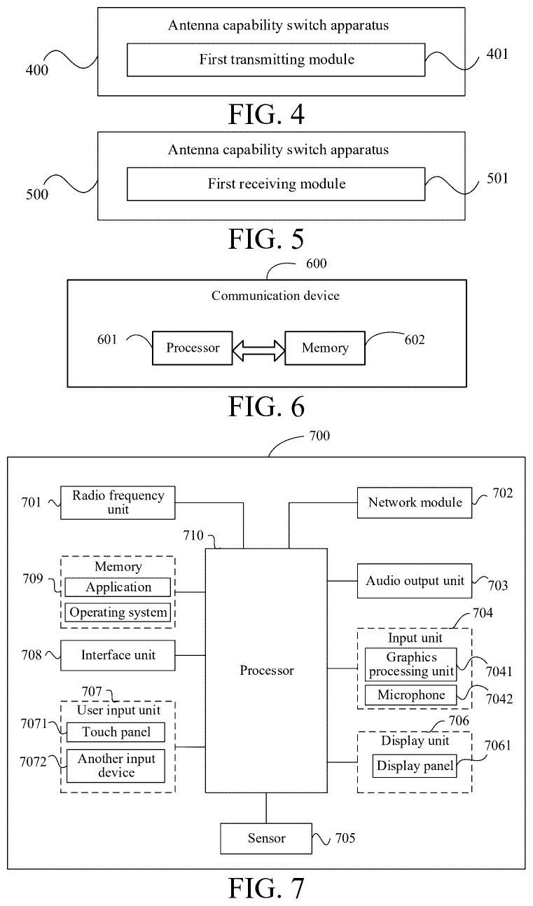

As shown in FIG. 4, an embodiment of this application further provides an antenna capability switch apparatus 400, applied to a terminal. The antenna capability switch apparatus 400 includes:
a first transmitting module 401, configured to transmit first information to a network-side device. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

As an example embodiment, the adjusting the antenna capability of the terminal in the first USIM card includes:
adjusting the antenna capability of the terminal on at least one carrier on the first USIM card;
or,
switching the antenna capability of the terminal between at least one pair of carriers on the first USIM card.

As an example embodiment, in a case that the information related to the antenna capability switch is used to request to switch the antenna capability of the terminal, the information related to the antenna capability switch includes at least one of the following:
an identifier of a first carrier, the first carrier being a carrier from which the antenna capability is expected to be switched by the terminal;
an identifier of a second carrier, the second carrier being a carrier to which the antenna capability is expected to be switched by the terminal;
a quantity of switched antennas;
time required for the terminal to perform an antenna switch between the first carrier and the second carrier; and
information of a carrier affected in a case that the terminal performs the antenna switch between the first carrier and the second carrier.

As an example embodiment, the apparatus further includes:
a second receiving module, configured to receive antenna capability switch information transmitted by the network-side device. The antenna capability switch information includes at least one of the following:
accepting the antenna capability switch request;
refusing the antenna capability switch request;
an identifier of a carrier indicating the terminal to switch the antenna capability;
an identifier of a carrier indicating the terminal to switch the antenna capability; and
a quantity of switched antennas.

As an example embodiment, the apparatus further includes:
a second transmitting module, configured to transmit first capability information to the network-side device. The first capability information is used to indicate a capability of the terminal to perform the antenna capability switch. The first capability information includes at least one of the following:
one or more band combinations of the terminal supporting the antenna capability switch;
one or more band pairs of the terminal supporting the antenna capability switch;
one or more carrier pairs of the terminal supporting the antenna capability switch;
time required for the terminal to perform the antenna capability switch;
a quantity of switched antennas supported by the terminal;
information of a band or a carrier affected during performing the antenna capability switch by the terminal; and
a characteristic supported by the terminal on a band combination supporting the antenna capability switch.

As an example embodiment, the apparatus further includes:
a third receiving module, configured to receive at least one set of antenna switch configuration information transmitted by the network-side device. Each set of antenna switch configuration information is associated with a pair of candidate carriers. A set of the antenna switch configuration information includes at least one of the following:
an identifier of a carrier from which the antenna capability is switched;
an identifier of a carrier to which the antenna capability is switched; and
a quantity of switched antennas.

As an example embodiment, in a case that the network-side device transmits at least two sets of antenna switch configuration information, the apparatus further includes:
a fourth receiving module, configured to receive second information transmitted by the network-side device. The second information is used to trigger an antenna switch corresponding to one set of antenna switch configuration information of the at least two sets of antenna switch configuration information.

As an example embodiment, in a case that the network-side device transmits one set of antenna switch configuration information, the one set of antenna switch configuration information is further used to trigger a corresponding antenna switch.

As an example embodiment, the first information further includes terminal assistance information, and the terminal assistance information includes at least one of the following:
multiple-in multiple-out MIMO layers that the terminal expects to decrease on a third carrier;
MIMO layers that the terminal expects to increase on a fourth carrier; and
purpose information for transmitting the terminal assistance information.

As an example embodiment, the first information further includes second capability information, and the second capability information includes:
a first capability set, the first capability set being used to indicate a terminal capability corresponding to the first USIM card in a case that the terminal does not switch the antenna capability from the first USIM card to another USIM card; and
a second capability set, the second capability set being used to indicate a terminal capability corresponding to the first USIM card in a case that the terminal switches the antenna capability from the first USIM card to another USIM card.

As an example implementation, the second capability information further includes:
time required for the terminal to switch from the first capability set to the second capability set.

As an example embodiment, the apparatus further includes:
a fifth receiving module, configured to receive antenna configuration information transmitted by the network-side device. The antenna configuration information includes at least one of the following:
maximum MIMO layers of the third carrier; and
maximum MIMO layers of the fourth carrier.

As an example embodiment, the apparatus further includes:
a third transmitting module, configured to transmit third information to the network-side device in a case that the antenna capability of a target carrier of the first USIM is switched. The third information is used to indicate an expected state of the target carrier. The expected state includes at least one of the following: a release state, an activated state, a deactivated state, and a dormant state.

As an example embodiment, the apparatus further includes:
a sixth receiving module, configured to receive fourth information transmitted by the network-side device. The fourth information is used to indicate the terminal to switch a state of the target carrier to a first state. The first state includes at least one of the following: a release state, an activated state, a deactivated state, and a dormant state.

As an example embodiment, the apparatus further includes:
a seventh receiving module, configured to receive fifth information transmitted by the network-side device, where the fifth information is used to indicate whether to allow the terminal to transmit the first information;
or,
a fourth transmitting module, configured to transmit sixth information to the network-side device, where the sixth information is used to indicate whether the terminal supports transmitting the first information.

In the embodiments of this application, a terminal transmits information related to an antenna capability switch to a network-side device corresponding to a first USIM card with the antenna capability switch, so that the network-side device can configure or schedule the terminal based on the information related to the antenna capability switch reported by the terminal, thereby reducing an influence of an antenna capability switch of a MUSIM card on performance of a current network side, and improving a user experience of a MUSIM card terminal.

It is to be noted that, the antenna capability switch apparatus according to the embodiments of this application is an apparatus that can perform the above antenna capability switch method. All embodiments of the above antenna capability switch method are applicable to the apparatus, and can achieve the same or similar effects.

As shown in FIG. 5, an embodiment of this application further provides an antenna capability switch apparatus 500, applied to a network-side device. The antenna capability switch apparatus 500 includes:
a first receiving module 501, configured to receive first information transmitted by a terminal. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

As an example embodiment, the adjusting the antenna capability of the terminal in the first USIM card includes:
adjusting the antenna capability of the terminal on at least one carrier on the first USIM card;
or,
switching the antenna capability of the terminal between at least one pair of carriers on the first USIM card.

As an example embodiment, in a case that the information related to the antenna capability switch is used to request to switch the antenna capability of the terminal, the information related to the antenna capability switch includes at least one of the following:
an identifier of a first carrier, the first carrier being a carrier from which the antenna capability is expected to be switched by the terminal;
an identifier of a second carrier, the second carrier being a carrier to which the antenna capability is expected to be switched by the terminal;
a quantity of switched antennas;
time required for the terminal to perform an antenna switch between the first carrier and the second carrier; and
information of a carrier affected in a case that the terminal performs the antenna switch between the first carrier and the second carrier.

As an example embodiment, the apparatus further includes:
a fifth transmitting module, configured to transmit antenna capability switch response information to the terminal. The antenna capability switch response information includes at least one of the following:
accepting the antenna capability switch request;
refusing the antenna capability switch request;
an identifier of a carrier indicating the terminal to switch the antenna capability;
an identifier of a carrier indicating the terminal to switch in the antenna capability;
and
a quantity of switched antennas.

As an example embodiment, the apparatus further includes:
an eighth receiving module, configured to receive first capability information transmitted by the terminal. The first capability information is used to indicate a capability of the terminal to perform the antenna capability switch. The first capability information includes at least one of the following:
one or more band combinations of the terminal supporting the antenna capability switch;
one or more band pairs of the terminal supporting the antenna capability switch;
one or more carrier pairs of the terminal supporting the antenna capability switch;
time required for the terminal to perform the antenna capability switch;
a quantity of switched antennas supported by the terminal;
information of a band or a carrier affected during performing the antenna capability switch by the terminal; and
a characteristic supported by the terminal on a band combination supporting the antenna capability switch.

As an example embodiment, the apparatus further includes:
a sixth transmitting module, configured to transmit at least one set of antenna switch configuration information to a terminal. Each set of antenna switch configuration information is associated with a pair of candidate carriers. A set of the antenna switch configuration information includes at least one of the following:
an identifier of a carrier from which the antenna capability is switched;
an identifier of a carrier to which the antenna capability is switched; and
a quantity of switched antennas.

As an example embodiment, in a case that the network-side device transmits at least two sets of antenna switch configuration information, the apparatus further includes:
a seventh transmitting module, configured to transmit second information to the terminal. The second information is used to trigger an antenna switch corresponding to one set of antenna switch configuration information of the at least two sets of antenna switch configuration information.

As an example embodiment, in a case that the network-side device transmits one set of antenna switch configuration information, the one set of antenna switch configuration information is further used to trigger a corresponding antenna switch.

As an example embodiment, the first information further includes terminal assistance information, and the terminal assistance information includes at least one of the following:
multiple-in multiple-out MIMO layers that the terminal expects to decrease on a third carrier;
MIMO layers that the terminal expects to increase on a fourth carrier; and
purpose information for transmitting the terminal assistance information.

As an example embodiment, the first information further includes second capability information, and the second capability information includes:
a first capability set, the first capability set being used to indicate a terminal capability corresponding to the first USIM card in a case that the terminal does not switch the antenna capability from the first USIM card to another USIM card; and
a second capability set, the second capability set being used to indicate a terminal capability corresponding to the first USIM card in a case that the terminal switches the antenna capability from the first USIM card to another USIM card.

As an example implementation, the second capability information further includes:
time required for the terminal to switch from the first capability set to the second capability set.

As an example embodiment, the apparatus further includes:
an eighth transmitting module, configured to transmit antenna configuration information to the terminal. The antenna configuration information includes at least one of the following:
maximum MIMO layers of the third carrier; and
maximum MIMO layers of the fourth carrier.

As an example embodiment, the apparatus further includes:
a ninth receiving module, configured to receive third information transmitted by the terminal. The third information is used to indicate an expected state of a target carrier from and/or to which the antenna capability is switched. The expected state includes at least one of the following: a release state, an activated state, a deactivated state, and a dormant state.

As an example embodiment, the apparatus further includes:
a ninth transmitting module, configured to transmit fourth information to the terminal. The fourth information is used to indicate the terminal to switch a state of the target carrier to a first state. The first state includes at least one of the following: a release state, an activated state, a deactivated state, and a dormant state.

As an example embodiment, the apparatus further includes:
a tenth transmitting module, configured to transmit fifth information to the terminal, where the fifth information is used to indicate whether to allow the terminal to transmit the first information;
or,
a tenth receiving module, configured to receive sixth information transmitted by the terminal, where the sixth information is used to indicate whether the terminal supports transmitting the first information.

In the embodiments of this application, a terminal transmits information related to an antenna capability switch to a network-side device corresponding to a first USIM card with the antenna capability switch, so that the network-side device can configure or schedule the terminal based on the information related to the antenna capability switch reported by the terminal, thereby reducing an influence of an antenna capability switch of a MUSIM card on performance of a current network side, and improving a user experience of a MUSIM card terminal.

It is to be noted that, the antenna capability switch apparatus according to the embodiments of this application is an apparatus that can perform the above antenna capability switch method. All embodiments of the above antenna capability switch method are applicable to the apparatus, and can achieve the same or similar effects.

The antenna capability switch apparatus in the embodiments of this application may be an electronic device, for example, an electronic device having an operating system, or a part in an electronic device, for example, an integrated circuit or a chip. The electronic device may be a terminal, or may be another device other than the terminal. For example, the terminal may include, but is not limited to, types of the terminal 11 listed above. The another device may be a server, a network attached storage (NAS), or the like. This is not specifically limited in the embodiments of this application.

The antenna capability switch apparatus according to the embodiments of this application can implement various processes implemented by the method embodiments as shown in FIG. 1 to FIG. 3 and achieve the same technical effects. To avoid repetition, details are not described herein again.

In some embodiments, as shown in FIG. 6, the embodiments of this application further provide a communication device 600, including a processor 601 and a memory 602. The memory 602 stores a program or instructions executable on the processor 601. For example, when the communication device 600 is a terminal, and the program or the instructions, when executed by the processor 601, implement various steps of embodiments of the above antenna capability switch method and can achieve the same technical effects. When the communication device 600 is a network-side device, the program or the instructions, when executed by the processor 601, implement various steps of embodiments of the above antenna capability switch method and can achieve same technical effects. To avoid repetition, details are not described herein again.

The embodiments of this application further provide a terminal, including a processor and a communication interface. The communication interface is configured to transmit first information to a network-side device. The network-side device corresponds to a first universal subscriber identity module USIM card of the terminal, and the first information includes information related to an antenna capability switch. The antenna capability switch includes at least one of the following: switching an antenna capability of the terminal from the first USIM card to another USIM card; switching an antenna capability of the terminal from another USIM card to the first USIM card; and adjusting the antenna capability of the terminal in the first USIM card. This terminal embodiment corresponds to the above terminal side method embodiment. Various implementation processes and implementations of the above method embodiments may all be applied to this terminal embodiment and can achieve the same technical effects. In some embodiments, FIG. 7 is a schematic diagram of a hardware structure of a terminal according to an embodiment of this application.

The terminal 700 includes, but is not limited to: at least part components such as a radio frequency unit 701, a network module 702, an audio output unit 703, an input unit 704, a sensor 705, a display unit 706, a user input unit 707, an interface unit 708, a memory 709, and a processor 710.

Those skilled in the art may understand that the terminal 700 may further include a power supply (for example, a battery) for supplying power to various components. The power supply may be logically connected to the processor 710 by a power management system, thereby realizing functions such as charging, discharging, and power consumption management by using the power management system. The terminal structure shown in FIG. 7 does not constitute a limitation on the terminal, and the terminal may include more or fewer components than shown, or combine some components, or have different component arrangements. Details are not described herein again.

It is to be understood that, in the embodiments of this application, the input unit 704 may include a graphics processing unit (GPU) 7041 and a microphone 7042. The GPU 7041 performs processing on image data of a static picture or a video obtained by an image acquisition apparatus (for example, a camera) in a video capture mode or an image capture mode. The display unit 706 may include a display panel 7061. The display panel 7061 may be configured in a form of a liquid crystal display, an organic light-emitting diode, or the like. The user input unit 707 includes at least one of a touch panel 7071 and another input device 7072. In some embodiments, the touch panel 7071 is referred to as a touchscreen. The touch panel 7071 may include two parts, that is, a touch detection apparatus and a touch controller. The another input device 7072 may include, but is not limited to, a physical keyboard, a functional key (for example, a volume control key or a switch key), a track ball, a mouse, and a joystick. Details are not described herein again.

In the embodiments of this application, after receiving downlink data from a network-side device, the radio frequency unit 701 may transmit the downlink data to the processor 710 for processing. In addition, the radio frequency unit 701 may transmit uplink data to the network-side device. Generally, the radio frequency unit 701 includes, but is not limited to, an antenna, an amplifier, a transceiver, a coupler, a low noise amplifier, a duplexer, and the like.

The memory 709 may be configured to store a software program or instructions and various data. The memory 709 may mainly include a first storage area for storing the program or the instructions and a second storage area for storing the data. The first storage area may store an operating system, an application or instructions required by at least one function (for example, a sound playback function and an image display function), and the like. In addition, the memory 709 may include a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), and a Direct Rambus RAM (DR RAM). The memory 709 in the embodiments of this application includes, but is not limited to, these and any other suitable types of memories.

The processor 710 may include one or more processing units. In some embodiments, the processor 710 is integrated with an application processor and a modem processor, where the application processor mainly processes operations involving an operating system, a user interface, an application program, and the like, and the modem processor mainly processes a wireless communication signal, for example, a baseband processor. It may be understood that, the above modem processor may not be integrated into the processor 710.

The radio frequency unit 701 is configured to transmit first information to a network-side device. The network-side device corresponds to a first universal subscriber identity module USIM card of the terminal, and the first information includes information related to an antenna capability switch.

The antenna capability switch includes at least one of the following:
switching an antenna capability of the terminal from the first USIM card to another USIM card;
switching an antenna capability of the terminal from another USIM card to the first USIM card; and
adjusting the antenna capability of the terminal in the first USIM card.

In the embodiments of this application, a terminal transmits information related to an antenna capability switch to a network-side device corresponding to a first USIM card with the antenna capability switch, so that the network-side device can configure or schedule the terminal based on the information related to the antenna capability switch reported by the terminal, thereby reducing an influence of an antenna capability switch of a MUSIM card on performance of a current network side, and improving a user experience of a MUSIM card terminal.

It is to be noted that, the terminal according to the embodiments of this application is a terminal that can perform the above antenna capability switch method. All embodiments of the above antenna capability switch method are applicable to the terminal, and can achieve the same or similar effects.

The embodiments of this application further provide a network-side device, including a processor and a communication interface. The communication interface is configured to receive first information transmitted by the terminal. The network-side device corresponds to a first universal subscriber identity module USIM card of the terminal, the first information includes information related to an antenna capability switch. The antenna capability switch includes at least one of the following: switching an antenna capability of the terminal from the first USIM card to another USIM card; switching an antenna capability of the terminal from another USIM card to the first USIM card; and adjusting the antenna capability of the terminal in the first USIM card. This network-side device embodiment corresponds to the above network-side device method embodiments. Various implementation processes and implementations of the above method embodiments may all be applied to the network-side device embodiments and can achieve the same technical effects.

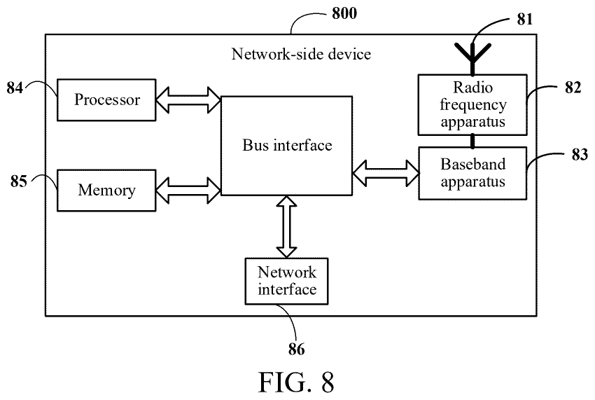

Some embodiments of this application further provide a network-side device. As shown in FIG. 8, the network-side device 800 includes: an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and transmits the received information to the baseband apparatus 83 for processing. In a downlink direction, the baseband apparatus 83 processes to-be-transmitted information, and transmits processed information to the radio frequency apparatus 82. The radio frequency apparatus 82 processes received information and transmits processed information through the antenna 81.

The method performed by the network-side device in the above embodiments may be implemented in the baseband apparatus 83. The baseband apparatus 83 includes a baseband processor.

The baseband apparatus 83 may include, for example, at least one baseband board. Multiple chips are arranged on the baseband board. As shown in FIG. 8, a chip is, for example, a baseband processor, and is connected to the memory 85 through a bus interface to invoke a program in the memory 85 to perform operations of a network device shown in the above method embodiments.

The network-side device may further include a network interface 86. The interface is, for example, a common public radio interface (CPRI).

In some embodiments, the network-side device 800 according to the embodiments of this application further includes: instructions or a program stored in the memory 85 and executable on the processor 84. The processor 84 invokes the instructions or the program in the memory 85 to perform the method performed by various modules shown in FIG. 5, and achieves the same technical effects. To avoid repetition, details are not described herein again.

The embodiments of this application further provide a readable storage medium. The readable storage medium stores a program or instructions. The program or the instructions, when executed by a processor, implement various processes of the embodiments of the above antenna capability switch method, and can achieve the same technical effects. To avoid repetition, details are not described herein again.

The processor is a processor in the terminal described in the above embodiments. The readable storage medium includes a computer-readable storage medium, such as a computer read-only memory ROM, a random access memory RAM, a magnetic disc, an optical disc, or the like.

The embodiments of this application additionally provide a chip. The chip includes a processor and a communication interface. The communication interface is coupled to the processor. The processor is configured to run a program or instructions to implement various processes of the embodiments of the above antenna capability switch method, and can achieve the same technical effects. To avoid repetition, details are not described herein again.

It is to be understood that the chip mentioned in the embodiments of this application may be referred to as a system-level chip, a system chip, a chip system, a system on a chip, or the like.

The embodiments of this application additionally provide a computer program/a program product. The computer program/the program product is stored in a storage medium. The computer program/the program product is executed by at least one processor to implement all processes of the embodiments of the above antenna capability switch method, and can achieve the same technical effects. To avoid repetition, details are not described herein again.

The embodiments of this application further provide a communication system, including: a terminal and a network-side device. The terminal may be configured to perform steps of the antenna capability switch method as described above. The network-side device may be configured to perform steps of the antenna capability switch method as described above.

It is to be noted that, terms “include”, “comprise”, or any other variation thereof herein is intended to cover a non-exclusive inclusion, so that a process, a method, an object, or an apparatus including a series of elements not only includes those elements but also includes other elements which are not clearly listed or further includes intrinsic elements of the process, the method, the object, or the apparatus. Without more limitations, elements defined by the sentence “including a” does not exclude that there are still other same elements in the processes, methods, objects, or apparatuses. In addition, it is to be pointed out that the scope of the method and apparatus in the implementations of this application is not limited to performing functions in the order shown or discussed, and may further include performing functions in a substantially simultaneous manner or in a reverse order according to the functions involved. For example, the described methods may be performed in an order different from the described order, and various steps may be added, omitted, or combined. In addition, features described with reference to some examples may be combined in other examples.

According to the description of the above implementations, those skilled in the art may clearly understand that the method in the above embodiments may be implemented by software in addition to a necessary universal hardware platform or by hardware. In most cases, the former is a more preferred implementation. Based on such an understanding, technical solutions of this application essentially or a part thereof that contributes to related arts may be embodied in a form of a software product. The computer software product is stored in a storage medium (for example, a ROM/RAM, a magnetic disc, or an optical disc), and includes several instructions for instructing a terminal (which may be a mobile phone, a computer, a server, an air conditioner, a network device, or the like) to perform the methods the embodiments of this application.

The embodiments of this application are described above with reference to the accompanying drawings, but this application is not limited to above specific implementations. The above specific implementations are merely illustrative rather than restrictive. Inspired by this application, those of ordinary skill in the art may still make multiple forms without departing from the essence of this application and the scope of protection of the claims, which all fall within the protection of this application.

What is claimed is:

1. An antenna capability switch method, comprising:
transmitting, by a terminal, first information to a network-side device, wherein the network-side device corresponds to a first universal subscriber identity module (USIM) card of the terminal, the first information comprises information related to an antenna capability switch, and
the antenna capability switch comprises at least one of the following:
switching an antenna capability of the terminal from the first USIM card to another USIM card;
switching an antenna capability of the terminal from another USIM card to the first USIM card; or
adjusting the antenna capability of the terminal in the first USIM card.

2. The method according to claim 1, wherein the adjusting the antenna capability of the terminal in the first USIM card comprises:
adjusting the antenna capability of the terminal on at least one carrier on the first USIM card; or
switching the antenna capability of the terminal between at least one pair of carriers on the first USIM card.

3. The method according to claim 1, wherein when the information related to the antenna capability switch is used to request to switch the antenna capability of the terminal, the information related to the antenna capability switch comprises at least one of the following:
an identifier of a first carrier, the first carrier being a carrier from which the antenna capability is expected to be switched out by the terminal;
an identifier of a second carrier, the second carrier being a carrier to which the antenna capability is expected to be switched in by the terminal;
a quantity of switched antennas;
time required for the terminal to perform an antenna switch between the first carrier and the second carrier; or
information of a carrier affected when the terminal performs the antenna switch between the first carrier and the second carrier.

4. The method according to claim 3, further comprising:
receiving antenna capability switch information transmitted by the network-side device, wherein the antenna capability switch information comprises at least one of the following:
accepting an antenna capability switch request;
refusing an antenna capability switch request;
an identifier of a carrier indicating the terminal to switch out the antenna capability;
an identifier of a carrier indicating the terminal to switch in the antenna capability; or
a quantity of switched antennas.

5. The method according to claim 1, wherein before transmitting the first information to the network-side device, the method further comprises:
transmitting first capability information to the network-side device, wherein the first capability information is used to indicate a capability of the terminal to perform the antenna capability switch, and the first capability information comprises at least one of the following:
one or more band combinations of the terminal supporting the antenna capability switch;
one or more band pairs of the terminal supporting the antenna capability switch;
one or more carrier pairs of the terminal supporting the antenna capability switch;
time required for the terminal to perform the antenna capability switch;
a quantity of switched antennas supported by the terminal;
information of a band or a carrier affected during performing the antenna capability switch by the terminal; or
a characteristic supported by the terminal on a band combination supporting the antenna capability switch.

6. The method according to claim 5, further comprising:
receiving, by the terminal, at least one set of antenna switch configuration information transmitted by the network-side device, wherein each set of antenna switch configuration information is associated with a pair of candidate carriers, and a set of the antenna switch configuration information comprises at least one of the following:
an identifier of a carrier from which the antenna capability is switched out;
an identifier of a carrier to which the antenna capability is switched in; or
a quantity of switched antennas.

7. The method according to claim 6, wherein when the network-side device transmits at least two sets of antenna switch configuration information, the method further comprises:
receiving, by the terminal, second information transmitted by the network-side device, wherein the second information is used to trigger an antenna switch corresponding to one set of antenna switch configuration information of the at least two sets of antenna switch configuration information.

8. The method according to claim 6, wherein when the network-side device transmits one set of antenna switch configuration information, the one set of antenna switch configuration information is further used to trigger a corresponding antenna switch.

9. The method according to claim 1, wherein the first information further comprises terminal assistance information, and the terminal assistance information comprises at least one of the following:
multiple-in multiple-out (MIMO) layers that the terminal expects to decrease on a third carrier;
MIMO layers that the terminal expects to increase on a fourth carrier; or
purpose information for transmitting the terminal assistance information.

10. The method according to claim 1, wherein the first information further comprises second capability information of the terminal, and the second capability information comprises:
a first capability set, being used to indicate a terminal capability corresponding to the first USIM card when the terminal does not switch the antenna capability from the first USIM card to another USIM card; and
a second capability set, being used to indicate a terminal capability corresponding to the first USIM card when the terminal switches the antenna capability from the first USIM card to another USIM card.

11. An antenna capability switch method, comprising:
receiving, by a network-side device, first information transmitted by a terminal, wherein the network-side device corresponds to a first universal subscriber identity module (USIM) card of the terminal, the first information comprises information related to an antenna capability switch, and
the antenna capability switch comprises at least one of the following:
switching an antenna capability of the terminal from the first USIM card to another USIM card;
switching an antenna capability of the terminal from another USIM card to the first USIM card; or
adjusting the antenna capability of the terminal in the first USIM card.

12. The method according to claim 11, wherein the adjusting the antenna capability of the terminal in the first USIM card comprises:
adjusting the antenna capability of the terminal on at least one carrier on the first USIM card; or
switching the antenna capability of the terminal between at least one pair of carriers on the first USIM card.

13. The method according to claim 11, wherein when the information related to the antenna capability switch is used to request to switch the antenna capability of the terminal, the information related to the antenna capability switch comprises at least one of the following:
an identifier of a first carrier, the first carrier being a carrier from which the antenna capability is expected to be switched out by the terminal;
an identifier of a second carrier, the second carrier being a carrier to which the antenna capability is expected to be switched in by the terminal;
a quantity of switched antennas;
time required for the terminal to perform an antenna switch between the first carrier and the second carrier; or
information of a carrier affected when the terminal performs the antenna switch between the first carrier and the second carrier.

14. The method according to claim 13, further comprising:
transmitting, by the network-side device, antenna capability switch response information to the terminal, wherein the antenna capability switch response information comprises at least one of the following:
accepting an antenna capability switch request;
refusing an antenna capability switch request;
an identifier of a carrier indicating the terminal to switch out the antenna capability;
an identifier of a carrier indicating the terminal to switch in the antenna capability; or
a quantity of switched antennas.

15. The method according to claim 11, wherein before receiving the first information transmitted by the terminal, the method further comprises:
receiving first capability information transmitted by the terminal, wherein the first capability information is used to indicate a capability of the terminal to perform the antenna capability switch, and the first capability information comprises at least one of the following:
one or more band combinations of the terminal supporting the antenna capability switch;
one or more band pairs of the terminal supporting the antenna capability switch;
one or more carrier pairs of the terminal supporting the antenna capability switch;
time required for the terminal to perform the antenna capability switch;
a quantity of switched antennas supported by the terminal;
information of a band or a carrier affected during performing the antenna capability switch by the terminal; or
a characteristic supported by the terminal on a band combination supporting the antenna capability switch.

16. The method according to claim 15, further comprising:
transmitting, by the network-side device, at least one set of antenna switch configuration information to the terminal, wherein each set of antenna switch configuration information is associated with a pair of candidate carriers, and a set of the antenna switch configuration information comprises at least one of the following:
an identifier of a carrier from which the antenna capability is switched out;
an identifier of a carrier to which the antenna capability is switched in; or
a quantity of switched antennas.

17. The method according to claim 16, wherein when the network-side device transmits at least two sets of antenna switch configuration information, the method further comprises:
transmitting, by the network-side device, second information to the terminal, wherein the second information is used to trigger an antenna switch corresponding to one set of antenna switch configuration information of the at least two sets of antenna switch configuration information.

18. The method according to claim 16, wherein when the network-side device transmits one set of antenna switch configuration information, the one set of antenna switch configuration information is further used to trigger a corresponding antenna switch.

19. The method according to claim 11, wherein the first information further comprises terminal assistance information, and the terminal assistance information comprises at least one of the following:
multiple-in multiple-out (MIMO) layers that the terminal expects to decrease on a third carrier;
MIMO layers that the terminal expects to increase on a fourth carrier; or
purpose information for transmitting the terminal assistance information.

20. A terminal, comprising a processor and a memory storing instructions, wherein the instructions, when executed by the processor, cause the processor to perform operations comprising:
transmitting first information to a network-side device, wherein the network-side device corresponds to a first universal subscriber identity module (USIM) card of the terminal, the first information comprises information related to an antenna capability switch, and
the antenna capability switch comprises at least one of the following:
switching an antenna capability of the terminal from the first USIM card to another USIM card;
switching an antenna capability of the terminal from another USIM card to the first USIM card; or
adjusting the antenna capability of the terminal in the first USIM card.
